(19) United States
(12) Patent Application Publication
(10) Pub. No.: US 2009/0277941 A1
(43) Pub. Date: Nov. 12, 2009

(54) APPARATUS AND METHOD FOR OPENING AMPOULES

(76) Inventor: Glen Stanley Riverstone, Queensland (AU)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 12/306,651

(22) PCT Filed: Jun. 27, 2007
(86) PCT No.: PCT/AU07/00894

§ 371 Date: Dec. 24, 2008

(30) Foreign Application Priority Data
Jun. 27, 2006 (AU) 2006903449

(51) Int. Cl. B67B 7/92; B26F 3/00

(52) U.S. Cl. 225/1; 225/93; 81/3.4

(57) ABSTRACT

An ampoule opener (1) has a cylindrical body portion (10) with a cavity (11) at an end thereof adapted to receive at least part of the head portion (53) of an ampoule (50). A retaining mechanism, such as an resiliently expandable O-ring (30), is provided at the entrance to the cavity (11) for retaining the head portion (53) at least partially within the cavity (11) after it has been inserted therein. The head portion (53) may be detached from the remainder of the ampoule (50) by holding the ampoule (50) in a first hand with the head portion uppermost, holding the cylindrical body portion (10) having the head portion (53) retained therein in the other hand with the thumb uppermost, and causing relative movement between the body portion (10) and the ampoule (50). The ampoule opener (1) includes a plunger (20) for ejecting the head portion (53) from the cavity after it has been detached.

### FIELD OF THE INVENTION

The present invention relates to apparatus and method for opening ampoules.

### BACKGROUND

Ampoules are small containers commonly used for storing medical substances such as liquids intended for hypodermic injection. A typical ampoule has a hollow body for containing a substance, a narrow neck, and a top or head portion which is smaller in volume than the body and which is greater in cross-section than the neck. The head portion and body are normally in fluid communication via a passageway in the neck.

Removal of the head portion from the body portion by breaking the ampoule at the neck allows access to the contents of the body portion. The contents may then be conveniently extracted from the body portion by insertion of a syringe needle through the passageway in the neck and aspiration of some or all of the contents into the syringe.

Opening of an ampoule may be achieved by holding the body using the thumb and one or more fingers of one hand, holding the head portion using the thumb and one or more fingers of the other hand so that the thumbs of the user are close together, and snapping the ampoule at the neck. However, opening the ampoule in this way may lead to the user being injured by sharp pieces of glass, especially if the head portion is inadvertently crushed. Other problems with opening of ampoules include regulating finger pressure on the ampoule head, strain to the forearm, especially after repeated operations, and safe disposal of the head.

In order to avoid injury to a user opening an ampoule, protective covers have been proposed for use during the opening operation. U.S. Pat. No. 4,405,069 discloses an ampoule breaker which has a pair of deformable flexible lip portions (preferably made from a cut-resistant flexible plastic) between which an ampoule head may be placed so that the lip portions serve as a protective barrier between the ampoule head and the gripping digits of the user. While this mitigates the problem of injury, the user must still control and regulate finger pressure upon the head in order to retain the head within the lip portions yet avoid crushing the ampoule head and creating hazardous glass fragments. A user may still suffer from repetitive strain injury if repeated ampoule opening operations are performed.

It is an aim of this invention to provide an apparatus and method for opening ampoules which overcome or ameliorate one or more of the disadvantages or problems described above, or which at least provide a useful alternative.

### SUMMARY OF THE INVENTION

In one broad form, this invention provides an apparatus for opening an ampoule of the type having a detachable head portion, the apparatus comprising:

a body portion having a cavity adapted to receive at least part of the head portion of the ampoule; and

retaining means on the body portion for retaining the head portion at least partially within the cavity after it has been inserted therein;

whereby the head portion may be detached from the remainder of the ampoule by relative movement between the body portion having the head portion retained at least partially therein and the remainder of the ampoule.

With the present invention, the user need not manually retain the head portion in the body portion; it is held therein by the retaining means while the head portion is detached from the remainder of the ampoule. Moreover, it is held therein by the retaining means until deliberately ejected as described below. After ejection of a detached ampoule head, the apparatus may be re-used.

In one embodiment, the retaining means has an expandable opening whose widest dimension at rest is less than the widest portion of the head portion. The retaining means is mounted on the body portion such that at least the widest portion of the head portion passes through the opening when the head portion is inserted into the cavity. The retaining means is expanded by the passage of the head portion therethrough and then automatically constricts behind the widest portion of the head portion to releasably retain the head portion at least partially in the cavity.

The retaining means is a preferably a resiliently expandable annular device such as an O-ring of elastomeric material. The elasticity of the O-ring allows it to be used with differently sized ampoule heads.

The retaining means may take other forms such as a four-lobed O-ring (of the type sometimes known as a quad ring) or a resiliently flexible washer.

The O-ring is suitably located at least partially in an annular groove adjacent the entrance of the cavity in the body portion.

In another embodiment, the retaining means comprises a plurality of fingers arranged around the entrance of the cavity in the body portion and defining an opening to the cavity. An actuating means is movable between a first position whereat the fingers are free to move radially outwardly to permit the passage of the widest portion of the head portion through the opening into the cavity, and a second position whereat the fingers are constricted behind the widest portion of the head portion to thereby retain the head portion at least partially in the cavity.

The actuating means may be in the form of a collar member axially slidable along the body portion.

Preferably, the ampoule opening apparatus of this invention further comprises a mechanism for ejecting the head portion of the ampoule from the cavity. This ejecting mechanism may suitably be an elongate member slidable within the body portion. The elongate member is manually operable to contact the head portion of the ampoule retained within the cavity and eject it from the cavity against the action of the retaining means.

More preferably, the elongate member is resiliently biased towards the entrance of the cavity in the body portion. The bias force is suitably a gentle force.

The elongate member preferably has an axis which is generally aligned with the centre of the entrance of the cavity, and has a concave portion at its end adapted to contact the head portion of the ampoule. In this manner, it retains the head portion centrally relative to the entrance of the cavity after it has been detached. This assists in ejecting the detached head portion from the cavity against the action of the retaining means.

The above described arrangement also provides ideal pressure points for the head portion to be detached easily. When the ampoule is held vertical and the body portion is levered forward to snap the head portion off, pressure occurs at the lowest point of the head portion on one side, and at the highest point of the head portion on the opposite side. This results in the ideal lever action with and less force being required.

Typically, the body portion of the ampoule opening apparatus is generally of elongate cylindrical shape, with the cavity at an end thereof. This enables the body portion to be used in a lever action, with the user positioning his/her hand with the thumb at the top, and the little finger towards the cavity end. This, in turn, results in less stress on the wrist as it used in a more ergonomical manner than that required for known ampoule openers.

Preferably the body portion is at least 3 cm in length, and more preferably at least 8 cm in length.

The external surface of the body portion may be provided with a flat portion extending axially along its length, to prevent the body portion from freely rolling about its axis.

The body portion may be provided with a cavity at each axial end thereof, the cavity at one end being sized differently from the cavity at the other end.

In alternative embodiments of the invention, the retaining means and ejecting mechanism may be formed as one mechanism, with the ejecting mechanism functioning by causing the retaining means to cease retaining the ampoule head portion.

In one such embodiment, the body portion of the ampoule opening apparatus includes a vice-like mechanism having a first side member and a second side member movable relative to the first side member. In this embodiment, the cavity is formed by a space between the first and second side members which are movable apart to accommodate the insertion of the head portion in the space. The retaining means comprises a mechanism for biasing the second side member towards the first side member so as to retain the head portion in the space therebetween after it has been detached from the remainder of the ampoule.

A restriction mechanism may be provided to prevent the second side member from moving substantially away from the first side member during opening of the ampoule. The restriction mechanism may be disabled by the action of inserting the head portion between the first and second side members.

Advantageously, the body portion is pistol shaped and has a handle at one end and the vice-like mechanism at the other end. The body portion may also include a manually actuated release mechanism for allowing the side members to move relatively apart against the bias of the retaining means, to thereby release the head portion of the ampoule from the vice-like mechanism and allow it to fall under gravity.

The body portion may be provided with an externally visible indicium adapted to be aligned, in use, with an indicium on the ampoule indicating the angular position of a weakened region thereon.

In another broad form, this invention provides a method of opening an ampoule of the type having a detachable head portion, the method comprising:

holding the ampoule in a first hand with the head portion uppermost,

holding in the other hand with the thumb uppermost, an ampoule opener having a cavity at its lower end adapted to receive the head portion of the ampoule,

inserting the head portion of the ampoule at least partially into the cavity, the ampoule opener having retaining means for retaining the head portion at least partially within the cavity after it has been inserted therein, and

causing relative movement of the ampoule opener having the head portion retained therein and the remainder of the ampoule to thereby detach the head portion from the remainder of the ampoule.

Preferably, the ampoule opener includes an elongate member slidable therein, and the method further comprises the step of manually operating the elongate member to contact the head portion of the ampoule retained within the cavity and eject it from cavity against the action of the retaining means. The elongate member is typically operated by depressing its upper end with the thumb of the other hand.

In order that the invention may be more readily understood and put into practice, one or more embodiments thereof will now be described, by way of example only, with reference to the accompanying drawings.

### BRIEF DESCRIPTION OF THE DRAWINGS

FIG. 1 is a schematic vertical cross-sectional view of an embodiment of an apparatus for opening ampoules;

FIG. 2(a) is a vertical cross-section of the body of the apparatus of FIG. 1;

FIG. 2(b) is a vertical cross-section of a release mechanism element of the apparatus of FIG. 1;

FIG. 3(a) shows an ampoule about to be inserted into the apparatus of FIG. 1;

FIG. 3(b) shows the ampoule head partially inserted into the apparatus;

FIG. 3(c) shows the ampoule head inserted into the apparatus;

FIG. 4(a) shows the apparatus with inserted ampoule immediately prior to opening of the ampoule;

FIG. 4(b) shows the apparatus and ampoule immediately after opening of the ampoule;

FIG. 5(a) shows the detached ampoule head retained in the apparatus;

FIG. 5(b) shows the detached ampoule head immediately after release/ejection from the apparatus;

FIGS. 6(a) and 6(b) correspond generally to FIGS. 4(a) and 4(b) but illustrate schematically first and second possible positions of a user's hands during opening of the ampoule;

FIGS. 7(a), 7(b) and 7(c) and FIG. 7(d) are schematic vertical cross-sectional views of alternative embodiments of an apparatus for opening ampoules;

FIGS. 8(a), 8(b) and 8(c) are schematic vertical cross-sectional views of a further alternative embodiment; and

FIG. 9(a) is a plan view of yet another embodiment of an apparatus for opening ampoules;

FIG. 9(b) is a central vertical cross-sectional view of the embodiment of FIG. 9(a);

FIGS. 10(a) and 10(b) correspond to FIGS. 9(a) and 9(b) with the apparatus in an alternative position, with an ampoule inserted;

FIG. 11 corresponds to FIGS. 9(b) and 10(b) and illustrates ejection of the ampoule head from the apparatus;

FIG. 12 is a schematic central vertical cross-section of a variation of the embodiment of FIGS. 9 to 11;

FIG. 13 is a schematic central vertical cross-section of a further variation of the embodiment of FIGS. 9 to 11;

FIGS. 14(a) to 14(f) illustrate schematically operation of an apparatus of the type illustrated in FIGS. 9 to 13;

FIG. 15 illustrates the position of a user's hand in operating an apparatus of the type illustrated in FIGS. 9 to 13; and

FIGS. 16(a) and 16(b) illustrate an embodiment of an apparatus for opening ampoules, accommodating use with ampoules of different sizes.

### DETAILED DESCRIPTION OF EMBODIMENTS

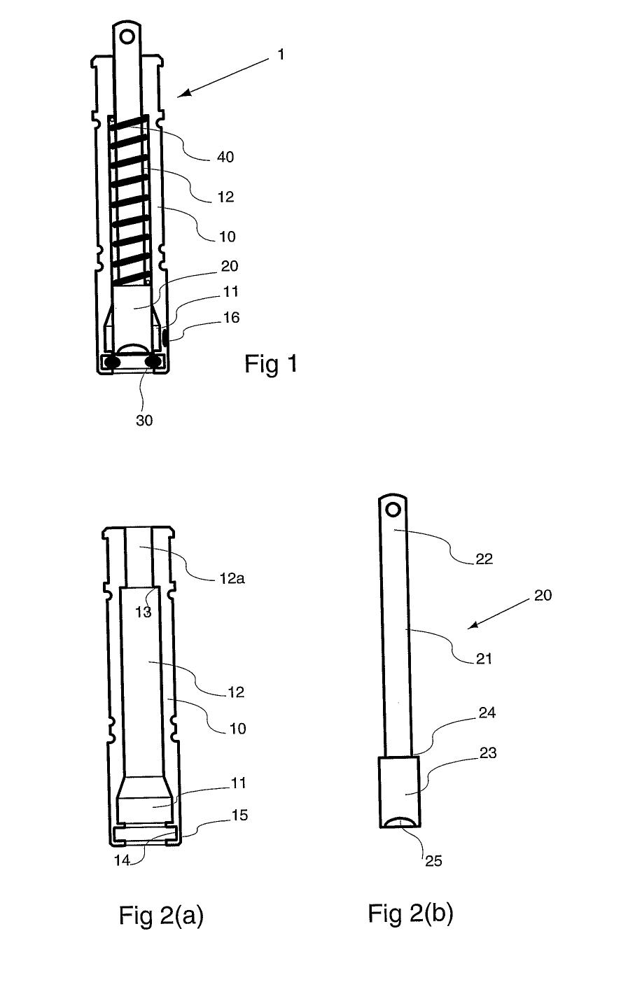

With reference to FIG. 1 an apparatus generally designated 1, for opening ampoules, comprises a body portion provided, in this embodiment, by a generally cylindrical body 10 with a receiving space, in this embodiment in the form of a cavity 11, at a first end thereof and a release mechanism which in this embodiment is provided by a plunger 20.

The apparatus 1 further comprises at least one retaining member which in this embodiment is in the form of an O-ring 30, provided generally at the opening of the cavity 11, that is, at the first end of the generally cylindrical body 10. The plunger 20 is retained in a central bore 12 of the generally cylindrical body 10, and is biased towards the first end of the generally cylindrical body 10, in this embodiment by a resilient member in the form of a helical spring 40.

Referring now especially to FIG. 2(a) the generally cylindrical body 10 is shown in vertical cross-section. The bore 12 is generally cylindrical and extends between the cavity 11 and a second end of the generally cylindrical body 10. Spaced apart from the cavity 11 the bore narrows to provide an annular shoulder 13 with a surface facing generally towards the first end of the generally cylindrical body 10 and a narrowed bore section 12a, which extends between the shoulder 13 and the second end of the generally cylindrical body 10.

The cavity 11 is open at the first end of the generally cylindrical body 10. Close to the first end of the generally cylindrical body 10 an annular groove 14 is provided in the internal wall of the cavity to receive and retain the O-ring 30. It will be appreciated that the internal diameter of the O-ring 30, when unstretched, is substantially smaller than the diameter of the opening of the cavity 11, so that it somewhat occludes the cavity. The external diameter of the O-ring 30, when unstretched, is considerably smaller than the diameter of the annular groove 14. The O-ring is sufficiently elastic that it can be stretched considerably by passage of an ampoule head therethrough, and the size of the groove 14 accommodates such stretching.

The generally cylindrical body 10 is, in this embodiment, also provided with an external flange or collar 15 at its first end. This may protect a user's hand from contact with the broken upper surface of an ampoule body and also provides a convenient region of increased width, allowing the apparatus to be stored in a rack (in an inverted orientation) which has an aperture corresponding to the cross-sectional shape of the part of the generally cylindrical body 10 which is not widened. As can be seen in FIG. 1, the generally cylindrical body 10 is also provided with a marking or indicium 16, close to the collar 15.

Use of the indicium will be described below.

Referring now to FIG. 2(b), the plunger 20 comprises an elongate generally cylindrical stem 21, at the, first, lower end of which is a coaxial cylindrical ampoule head engaging portion 23 with radius greater than the radius of the elongate generally cylindrical stem 21. At a second, upper end of the stem 21 is an end portion 22 thereof, which may be regarded as an operating portion, which in use is operated by the thumb of a user.

The ampoule head engaging portion is provided with an upwardly facing shoulder 24 where it joins the stem 21 and is further provided with a concave region 25 at an underside thereof. The concave region 25 is shaped to receive and engage part of an ampoule head.

As shown in FIG. 1, when assembled the apparatus is arranged with the plunger 20 substantially within the cylindrical body 10. The spring 40 is fitted around part of the stem 21 and located substantially in the bore 12. The spring is somewhat compressed between the shoulder 13 of the cylindrical body 10 and the shoulder 24 of the plunger and thus gently biases the plunger 20 towards the first end of the cylindrical body 10. However the ampoule-head engaging portion 23 of the plunger 20 is prevented from existing the cavity 11 by the O-ring 30 (or other retaining member).

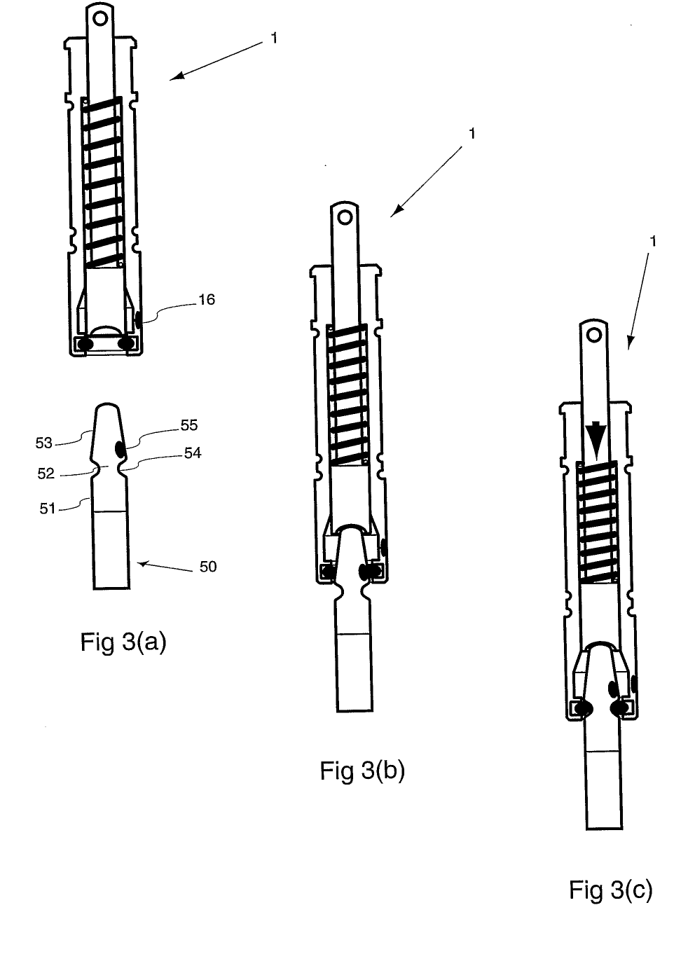

FIGS. 3(a), 3(b) and 3(c) illustrate insertion of part of an ampoule 50 into the apparatus 1. The ampoule 50, has a body 51, a neck 52 and a head 53. The ampoule 50 is provided with a scored or otherwise weakened region 54 on its neck 52, to facilitate opening, and with an indicium 55, typically in the form of a dot of paint or pigment, to indicate the angular position of the weakened region 54.

FIG. 3(a) shows the ampoule 50 adjacent the apparatus 1. The plunger 20 is gently biased towards the first end of the cylindrical body 10 (and thus also towards the O-ring 30) and is in contact with the O-ring 30. The O-ring is in substantially its equilibrium, unstretched, state. The indicium 16 on the body is aligned with the indicium 54 on the ampoule, by a user, so that even with the ampoule head 53 within the apparatus 1 the position of the weakened region 54 will be evident to a user, assisting application of an opening force in an appropriate direction to provide a clean opening operation of the ampoule 50.

FIG. 3(b) shows the ampoule 50 and apparatus 1 with the ampoule head 53 being inserted into the cavity 11. The O-ring 30 is stretched by passage of the widest part of the ampoule head 53 therethrough. The ampoule head 53 engages the concave region 25 of the ampoule head engaging portion 23. The plunger 20 is moved towards the second end of the cylindrical body 10, and away from the first end of the cylindrical body 10 by the force applied by the ampoule head 53. The spring 40 is partially compressed.

FIG. 3(c) shows the situation with the ampoule head 53 inserted into the cavity 11. The O-ring 30 has contacted to its equilibrium (or close to equilibrium) size and substantially surrounds the neck 52 of the ampoule 50. A lower part of the ampoule head is engaged by the O-ring 30, and the resilience of the O-ring 30 offers resistance which prevents the ampoule head 53 from exiting the cavity 11. The plunger 20, being biased by the spring 40 is kept in contact with the ampoule head 52, and also provides a gentle force keeping the bottom part of the ampoule head 52 in contact with the O-ring 30. The bias force is indicated by the arrow BF in FIG. 3(c).

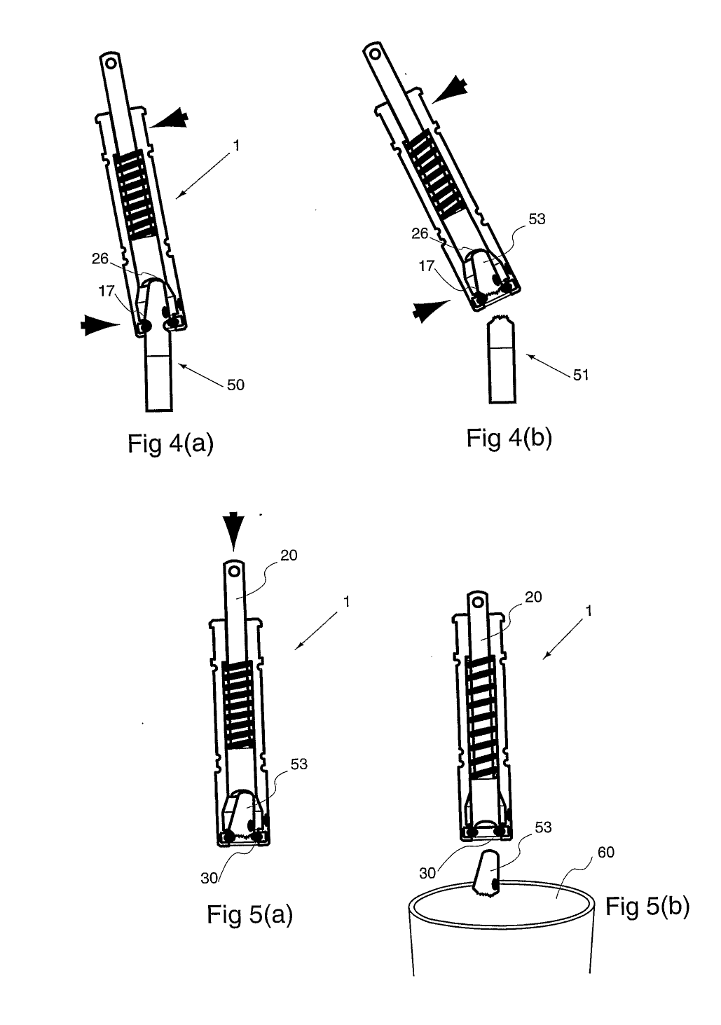

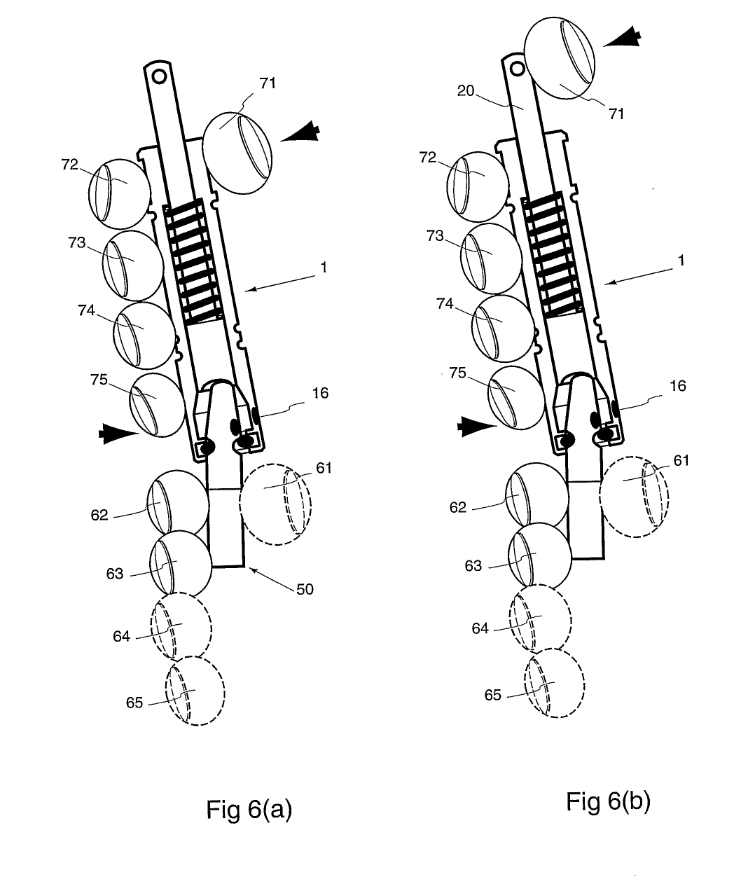

FIGS. 4(a) and 4(b) show schematically a preferred way of operating the apparatus 1 in order to break or open the ampoule 50. As positioned in FIG. 4(a) the ampoule body 51 is preferably held substantially upright in a first (typically the left) hand of a user and the apparatus 1 held in the other (typically the right) hand of a user, as will be further described below with reference to FIG. 6. The apparatus 1 is then moved relative to the ampoule body 51 in order to apply an opening force to the ampoule head and break the ampoule 50 at its neck 52. More specifically, in the illustrated embodiment an engagement region 26 of the concave region 25 of the plunger 20 engages an upper part of the ampoule head 53, and an engagement region 17 of the internal wall of the cavity 11 engages a lower part of the ampoule head 53. The forces are preferably applied as indicated by the arrows in FIGS. 4(a) and 4(b), so that a tensile force is applied to the weakened region 54 of the ampoule neck 52. The forces are easily applied manually by a user who is holding the ampoule body 52, substantially vertically orientated, in a first (eg a left) hand, with the navicular (or thumb) side of the first hand upwards, and is holding the apparatus 1, substantially vertically orientated, in the other, second (eg a right) hand, with the navicular (or thumb) side of the second hand upwards. The opening operation will then correspond to a natural action, avoiding undue strain or discomfort, and allowing the ampoule to be retained in an upright position during opening, reducing the risk of spilling the ampoule contents.

As shown in FIG. 4(b), after the ampoule is opened the ampoule head 53 is retained in the cavity 11, held gently between the biased plunger 20 and the O-ring 30, until a user wishes to eject the ampoule head 53. Thus the ampoule head 53 is effectively automatically retained in the apparatus 1 until deliberately ejected.

FIGS. 5(a) and 5(b) show schematically a preferred way of operating the apparatus 1 in order to eject the ampoule head, for example into a sharps safe container 60. As shown in FIG. 5(a) the plunger is forced gently towards the first end of the cylindrical body 10. This force can be easily applied by the thumb of a user operating upon the second end of the stem 21, especially given the hand positioning described above, which will be further described with reference to FIGS. 6(a) and (6b). Forcing the plunger 20 towards the O-ring 30 forces the lower part of the ampoule head against the O-ring 30 with considerably more force than was applied by the spring 40. This deforms or stretches the O-ring 30 enough to allow passage of the ampoule head therethrough. As shown in FIG. 5(b) the ampoule head can easily, deliberately and predictably be ejected into a suitable sharps safe container 60. Once the ampoule head has been ejected the plunger 20 rests, in its equilibrium position, against the O-ring 30 (which will again be unstretched). Easy, deliberate and predictable ejection of the ampoule head into a sharps safe container is an important safety feature of preferred embodiments.

The preferred hand positions of a user, during operation of the apparatus 1 are illustrated schematically in FIGS. 6(a) and (6b). As shown in FIG. 6(a) a user is holding the ampoule 53, substantially vertically orientated, in a first, left, hand with the navicular (or thumb) side of the first hand upwards. Thus the thumb 61 and index finger 62 of the first hand are towards the top of the ampoule 53, and the middle finger 63, ring finger 64 and little finger 65 are successively lower. (The ring finger 64 and little finger 65 are typically below the ampoule and not engaged with the ampoule and are therefore shown in broken lines.) The user is holding the apparatus 1, substantially vertically orientated, in a second, right, hand with the navicular (or thumb) side of the second hand upwards. Thus the thumb 71 and index finger 72 of the second hand are towards the top of the apparatus 1, and the middle finger 73, ring finger 74 and little finger 75 are successively lower. It should be appreciated that although the fingertips only are shown in order to indicate the hand orientations, the user may use the whole hands in holding the apparatus (and/or ampoule) and holding these objects with the fingertips only is not necessarily recommended or desirable.

The thumb 71 of the second hand may be placed on the plunger 20 during the opening operation if desired, as illustrated in FIG. 6(b) although in this case care must be taken that the force applied by the thumb doesn't inadvertently move the plunger axially. However, it will be appreciated that the thumb can be easily moved to the plunger 20 after opening the ampoule 50 to allow easy ejection of the ampoule head without requiring significant moment of the hand or fingers of the hand holding the apparatus and without requiring an unnatural or uncomfortable hand position to be used.

As illustrated in FIGS. 6(a) and 6(b) the user may be considered to be to the right of the apparatus 1, and holding the apparatus and ampoule directly and centrally in front of him. The right hand of the user would be behind the apparatus 1 as viewed, with the thumb 71 and fingers 72, 73, 74, 75 projecting towards the viewer (or out of the paper). The left hand of the user would be in front of the ampoule as viewed, with the thumb 61 and fingers 62, 63, 64, 65 projecting away from the viewer (or into of the paper).

It will be appreciated that the illustrated hand orientation is the natural orientation for holding a vertically orientated elongate object in each hand, and results in natural arm position. In contrast, holding the upper hand with the thumb or navicular side of the hand downwards (as is required in ampoule opening procedures in which the ampoule body is held vertical in one hand and the ampoule head is held between the thumb and first finger of the other hand) results in an uncomfortable arm position with the elbow raised. Use of some prior art ampoule opening devices has required the ampoule to be orientated other than substantially vertically in order for a user to attain a less uncomfortable position, resulting in an increased likelihood of spilling the ampoule contents upon opening.

It will be appreciated that it is desirable to provide ampoule head retaining member(s), such as the O-ring (although different arrangements could be used) operation of which to retain an ampoule head does not require a gripping pressure to be applied to the ampoule from outside the apparatus in order to retain the ampoule head during the opening operation. This eliminates the need to position the thumb and index finger close to, and on either side of, the ampoule head, and allows the part of the apparatus where the ampoule head is retained to be held by the relatively weak ulna side of the hand. Thus the apparatus can be held by a hand in the natural and comfortable “thumb up” position. Using an apparatus body that is approximately as long as the width of a user's hand provides ample leverage, allows a user's hand to fit comfortably around the apparatus body, and allows the ampoule neck to be close to, and between, both hands during the opening operation while retaining easy access to the part of the plunger (ejecting mechanism) which extends from the second end of the body. For this reason the body of the apparatus is preferably between about 5 cm and about 15 cm in length, and most preferably between about 8 cm and 12 cm in length.

A further benefit of the preferred embodiment is that because the O-ring has considerable elasticity a relatively wide range of ampoule head diameters can be admitted and retained in the apparatus. This allows a wide range of ampoule sizes to be opened using a single device (rather than the device being limited to only a very limited range of ampoule sizes, as might have been expected).

It will be appreciated that many variations are possible. For example the cavity could be shaped so that a part of the cavity wall contacts and operates on the upper part of the ampoule head during the opening operation. The apparatus need not necessarily be generally cylindrical or generally symmetrical, although these characteristics are currently considered desirable in a preferred embodiment. In a preferred embodiment the body is made from metal. The body may be cast or lathe formed steel or aluminium. In alternative embodiments the body may be moulded from a suitable plastic.

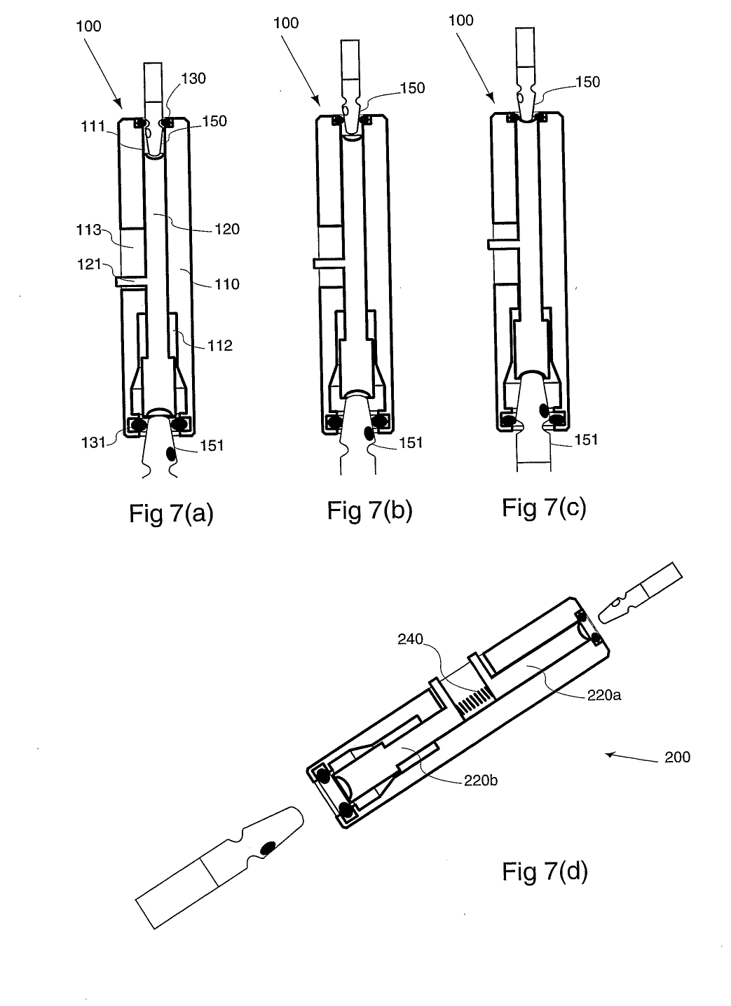

One alternative embodiment 100 is illustrated in FIGS. 7(a), 7(b) and 7(c). The apparatus 100 has a body 110 defining a smaller cavity 111, at one end, with an associated smaller retaining member 130, for accommodating smaller ampoule heads 150, and a larger cavity 112 at the other end, with an associated larger retaining member 131 for accommodating larger ampoule heads 151. This allows a single apparatus 100 to be used on a larger range of ampoule sizes. Moveable within the body 110 is an ejection member 120. The ejection member 120 can be operated, by contact of a user's thumb with an operating portion 121, in order to eject ampoule heads from the larger cavity 112 (as shown in FIG. 7(a)) or the smaller cavity 111 (as shown in FIG. 7(c)). The operating portion 121 extends generally perpendicular to the axis of the ejection member 120 and projects through a slot 113 in an axially central part of the body 110. FIG. 7(b) illustrates an intermediate position of the ejection member 120.

A further variation, in the form of an apparatus 200 is illustrated in FIG. 7(d). This embodiment is similar to the embodiment 100, except that rather than having a single ejection member, first and second ejection members 220a, 220b are provided, each biased towards a respective retaining member 230, 231. This allows more predictable engagement with an ampoule head, and more predictable retention of the ampoule head between the ejection member and the retaining member prior to ejection of the ampoule head. In the illustrated embodiment the bias is provided by a resilient member 240, such as a spring, provided between the second ejection members 220a, 220b. However, any suitable alternative mechanism may be used.

Retaining arrangements other than an O-ring could be used, although it is currently preferred that the retaining member is an O-ring, or a similar element with a degree of intrinsic elasticity, such as a quad ring, flexible washer or the like.

Ejection arrangements other than a plunger could also be used.

For example, in some alternative embodiments several separate retaining members angularly spaced around a cavity in a body portion are provided. Small ball bearings, inwardly spring biased, and set into small niches in the internal wall of the cavity could be used.

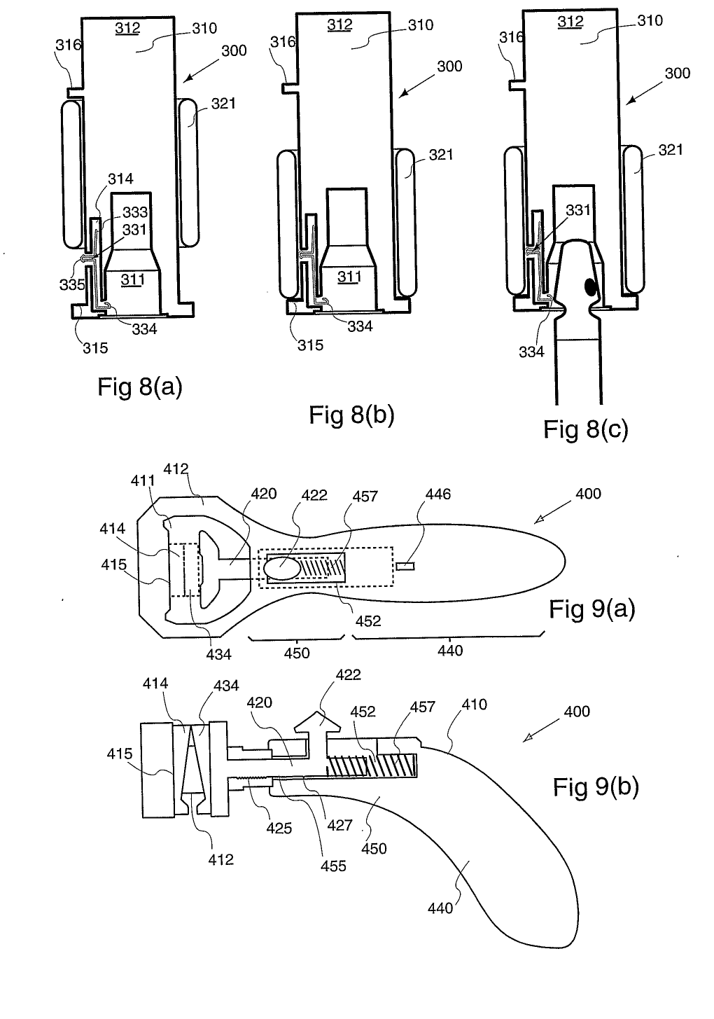

One embodiment, generally designated 300 and illustrated in FIGS. 8(a) to 8(c), provides a number of separate retaining members, one of which is shown.

The retaining member is in the form of a resiliently flexible retaining element 331 located generally within a recess 314. A first end of the flexible retaining element 331 is located at a fixed position within the recess 314 and the second end 334, which is adapted to engage the head of an ampoule, is provided so that it can project resiliently into the ampoule head receiving space 311.

A projecting part 335 of the flexible retaining element 331 projects to the exterior of the apparatus 300. An axially moveable collar in the form of a cylindrical member 321 extends around an exterior cylindrical surface of a body portion 310 of the apparatus, such that it can be moved between a non-operative position in which it does not engage the projecting part 335 (as illustrated in FIG. 8(a)) and an operative position in which it engages the projecting part 335.

When the cylindrical member 321 engages the projecting part 335 (as illustrated in FIGS. 8(b) and 8(c)) the flexible retaining element 331 is forced inwards so that the second end 334 projects into the ampoule head receiving space 311. In this configuration the flexible retaining element 331 (or more accurately a plurality of flexible retaining elements in combination) can receive and retain an ampoule head in a manner that will be apparent from consideration of FIGS. 8(a), (b) and 8(c) and the description provided above relating to the apparatus 1.

When the cylindrical member 321 does not engage the projecting part 335 (as illustrated in FIG. 8(a)) the second end 334 of the flexible retaining element 331 is not forced inwards, and does not project substantially into the ampoule head receiving space 311.

In order to use the apparatus 300 a user first moves the cylindrical member 321 into the operating position (as illustrated in FIGS. 8(b) and 8(c)) and then operates the device by inserting an ampoule head and breaking the ampoule substantially as described above in relation to the apparatus 1. After the ampoule head is detached from the rest of the ampoule it will be retained in the ampoule head receiving space 311 by the flexible retaining element(s) 331.

In order to eject the ampoule head the user holds the apparatus 300 in a substantially upright position and moves the body portion 310 downwardly relative to the cylindrical member 321. This may conveniently be achieved by holding the cylindrical member 321 in the palm and or one or more fingers of a hand, and pressing down on an upper surface portion 312 of the body portion 310 with the thumb of the same hand. This allows the flexible retaining element 331 to return to the non-operative position as illustrated in FIG. 8(a), so that the ampoule head is no longer retained and may fall from the ampoule head receiving space by gravity.

The axial movement of the cylindrical member 321 relative to the body portion 310 is constrained, for example by abutment portions 315, 316 of the body portion 310.

It will be appreciated that means, such a friction or abutment element, may be provided to help retain the cylindrical member 321 in the operative position except when specifically operated to be forced into the non-operative position. Alternatively or additionally the cylindrical member 321 may be biased towards the operative position so that the user does not deed to perform the operation of moving the cylindrical member 321 into the operating position, and so that a positive ejection action is provided in use.

It will be appreciated that in this embodiment the ejecting mechanism is provided at least in part by the retaining member(s) and other parts of the apparatus which, when operated appropriately, operate (or cease to operate) on the retaining member(s) so that the ampoule head is no longer retained by the retaining member(s) in the ampoule head receiving space.

A further embodiment is illustrated in FIGS. 9(a) to 11 and is generally designated 400. The apparatus 400 comprises a body portion provided, in this embodiment, by a generally pistol-shaped body 410. The apparatus 400 has a broadened portion 412 defining an opening 411, for receiving an ampoule head, at a first end thereof and a handle part 440, which extends about half the length of the body 410, at a second end thereof. A generally central portion 450 is provided between, and connects, the handle part 440 and the broadened portion 412.

The apparatus 400 further comprises at least one ampoule head retaining member which in this embodiment is formed separately to the body 410 and is in the form of an ampoule-head engaging element 434. The ampoule-head engaging element 434 may be moved within the opening 411, in order that an ampoule head can be gripped between the ampoule head engaging element 434 and an ampoule head engaging part 414 located on a wall 415 of the broadened portion 412.

The apparatus 400 further comprises an ampoule-head releasing mechanism (for allowing ejection of the ampoule head at when desired) which in this embodiment is provided by a releasing element 420, which is connected to the ampoule-head engaging element 434 and which can move relative to the central portion 450 in order to move the ampoule-head engaging element 434 relative to the broadened portion 412. The releasing element 420 is located partially in a cavity 452 in the central portion 450. The releasing element 420 is biased towards the ampoule-head engaging part 414 and wall 415 by a resilient member which in this embodiment is in the form of a helical spring 457 located in the cavity 452. The releasing element 420 is provided with an operating portion 422 which projects upwardly out of the top surface of the central portion 450 and which can be used to move the releasing element 420 as desired. The operating portion 422 is suitably located for operation by the thumb of a user's hand when that hand is holding the apparatus by the handle part 440.

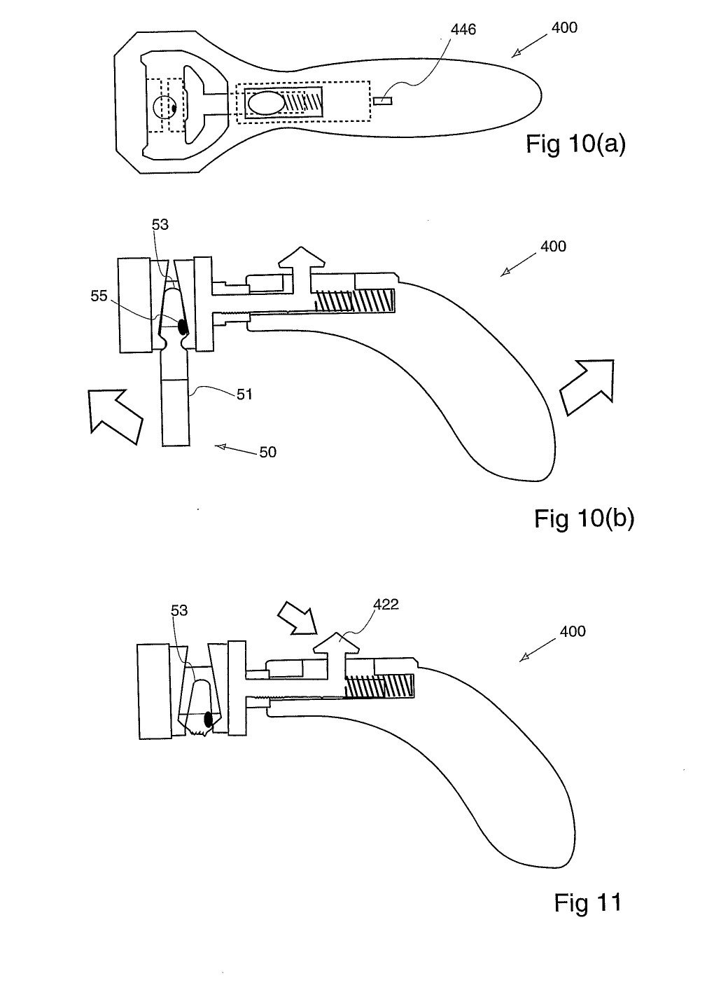

It will be appreciated that an ampoule head 53 can be inserted between the ampoule-head engaging element 434 and the ampoule-head engaging part 414, causing the ampoule-head engaging element 434 and the releasing element 420 to be pushed, by the ampoule head, slightly away from the ampoule-head engaging part 414. The ampoule head 53 is preferably inserted so that the indicium 55 on the ampoule head (indicating the position of a weakened region of the ampoule neck) is aligned with an indicium 446 provided at a generally laterally central position on the apparatus 400. The ampoule head 53 will then be retained between the ampoule-head engaging element 434 and the ampoule-head engaging part 414, as shown in FIGS. 10(a) and 10(b), because of the bias applied to the releasing element 420.

It will be appreciated that in use both the ampoule body 51 and the apparatus 400 are preferably held with the navicular or thumb side of the hand higher than the ulna or little-finger side. The ampoule can be opened by relative rotation of the apparatus 400 and ampoule body 51, for example in the directions illustrated by the large arrows in FIG. 10(b). The ampoule head 53 will then be retained until the ampoule-head engaging element 434 is retracted, as illustrated in FIG. 11. This retraction may be conveniently performed by a user, by sliding the operating portion 422 away from the broadened portion 412 using the thumb of the hand holding the apparatus.

The opening operation maar be impeded or prevented if the ampoule-head engaging element 434 retracts unduly far from the ampoule-head engaging part 414 due to reactive forces from the ampule head during the attempted opening operation. A retraction limiting mechanism may be provided to prevent such undue retraction.

The bias force applied by the spring 457, along with the geometry of the apparatus and the provision of contouring on the ampoule-head engaging element 434 and ampoule-head engaging part 414 so that the ampoule head 53 is a snug fit between these parts, may be adequate to prevent undue retraction of the ampoule-head engaging element 434 from the ampoule-head engaging part 414 during the opening operation. In this case no additional retraction limiting mechanism to prevent undue retraction will be needed, and the apparatus may be in the form of embodiment 600 as illustrated in FIG. 13 (which is similar to the embodiments of FIGS. 9(a) to 11, but without the retraction limiting mechanism, which will be described below). If a retraction limiting mechanism is required, then a mechanism such as that shown in shown FIGS. 9(a) to 11 may be provided.

As illustrated in FIGS. 9(a) to 11, a plurality of downwardly projecting ratchet-like teeth 422 is provided on an underside of the releasing element 420. The ratchet-like teeth 422 are adapted to interact with one or more upwardly projecting ratchet-like teeth 455 provided on the bottom of the cavity 452. When the downwardly projecting ratchet-like teeth 422 interact with the one or more upwardly projecting ratchet-like teeth 455 retraction of the ampoule-head engaging element 434 (ie movement to the left as illustrated in FIGS. 9(a) and 10(a)) is prevented. However, in this embodiment the releasing element 420 is a slightly loose fit in the cavity 452, and it will be appreciated that as an ampoule head is inserted into the ampoule receiving space it applies a small upward force on the ampoule-head engaging element 434. This is adequate to lift the downwardly projecting teeth 422 away from the one or more upwardly projecting ratchet-like teeth 455 so that they do not interact. Thus retraction of the ampoule-head engaging element 434 is not prevented during insertion of the ampoule head. However, during the opening operation the ampoule head provides a component of the reactive force on the ampoule-head engaging element 434 in a downward direction, so that the downwardly projecting teeth 422 do interact with the one or more upwardly projecting ratchet-like teeth 455. Thus retraction of the ampoule-head engaging element 434 is prevented during the opening operation.

A downwardly projecting fulcrum 427 is provided on the releasing element 420, axially between the operating portion 422 and the ratchet-like teeth 422, so that when the operating portion 422 is pushed downwards by a user's thumb, the ratchet-like teeth 422 are lifted away from the ratchet-like teeth 455 and the releasing element 420 can be moved without interference from the teeth 422, 455. This allows easy release/ejection of the ampoule head. It will be appreciated that in this embodiment the retraction limiting mechanism does not require additional operations by the user, but acts as required as the user operates the apparatus.

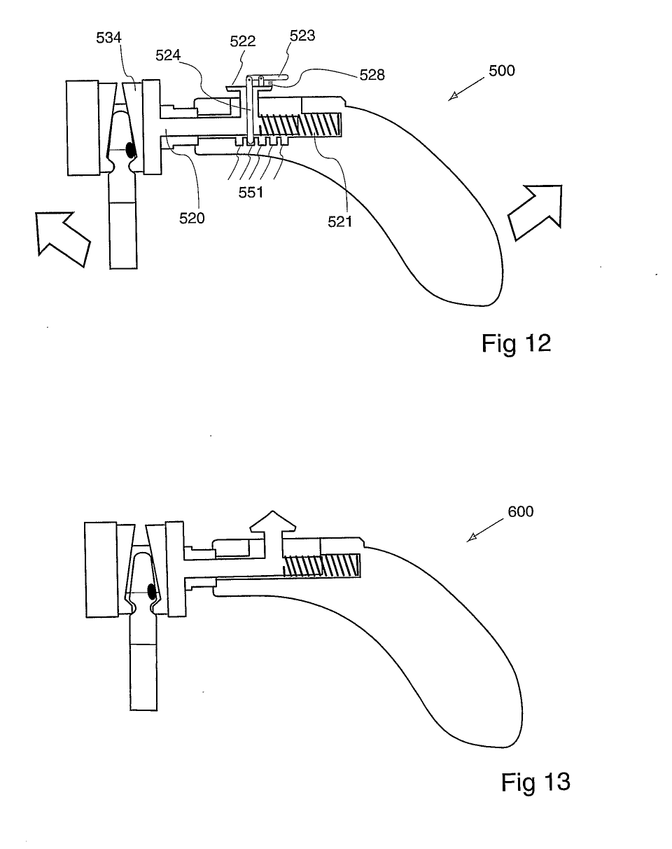

FIG. 12 illustrates an embodiment 500, with an alternative retraction limiting mechanism, in which an ampoule-head engaging element 534 is substantially prevented from retracting except when a user is depressing a release member 523. The embodiment 500 is similar in many ways to the embodiment 400 and the same nomenclature (but different reference numerals, since the first digit will be a 5, rather than a 4) will be used to designate corresponding parts. It will be apparent that there are many ways of preventing or limiting retraction of an ampoule-head engaging element except when a release member is depressed, and any appropriate arrangement could be used.

In the embodiment 500, the release member 523 is provided on an operating portion 522 of the releasing element 520. A catch member 524, attached to the releasing element 520 is biased downwardly by a spring 528, and engages in one of a number of indentations 551 provided in the cavity 521, preventing retraction of the releasing element 520 when the release member 523 is not depressed. When the release member 523 is depressed, the catch member 524, which is coupled to the release member 523 is moved upwardly and is disengaged from the recesses 551, allowing movement of the releasing element 520, and retraction of the ampoule-head engaging element 534, to allow release and ejection of the ampoule head.

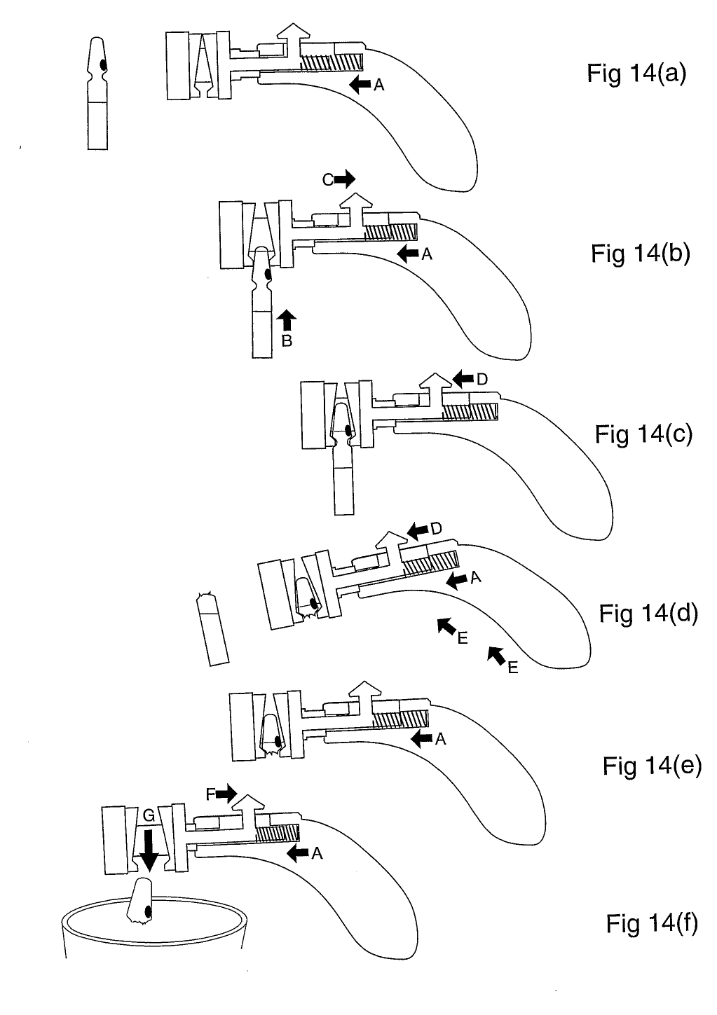

FIGS. 14(a) to 14(f) illustrate schematically operation of an apparatus of the type illustrated in FIGS. 9 to 13.

FIG. 14(a) shows the apparatus prior to insertion of an ampoule. FIG. 14(b) shows the apparatus and an ampoule with the ampoule head partially inserted into the apparatus. FIG. 14(c) shows the apparatus and ampoule with the ampoule head inserted into the apparatus immediately prior to opening of the ampoule. FIG. 14(d) shows the apparatus and ampoule immediately after opening of the ampoule. FIG. 14 (e) shows the detached ampoule head retained in the apparatus. FIG. 14(f) shows the apparatus and detached ampoule head immediately after release/ejection of the detached ampoule head from the apparatus.

The arrows designated A illustrate the bias force applied to the releasing element. The arrows designated B illustrate the direction of movement of the ampoule and/or ampoule head. The arrow designated C illustrates the direction of movement of the releasing element as an ampoule head is inserted. The arrows designated D illustrates a force which may, in some variations in which a retraction limiting mechanism is not included or is not adequate, be applied by a user's thumb to prevent undesirable retraction of the ampoule-head engaging element and releasing element during the ampoule opening operation. The arrows designated E illustrate a possible direction of movement of the apparatus relative to the ampoule during and immediately after the ampoule opening operation. The arrow designated F illustrates a force applied by a user's thumb to the operating portion, and the direction of movement of the releasing element to effect release/ejection of the ampoule head (arrow G).

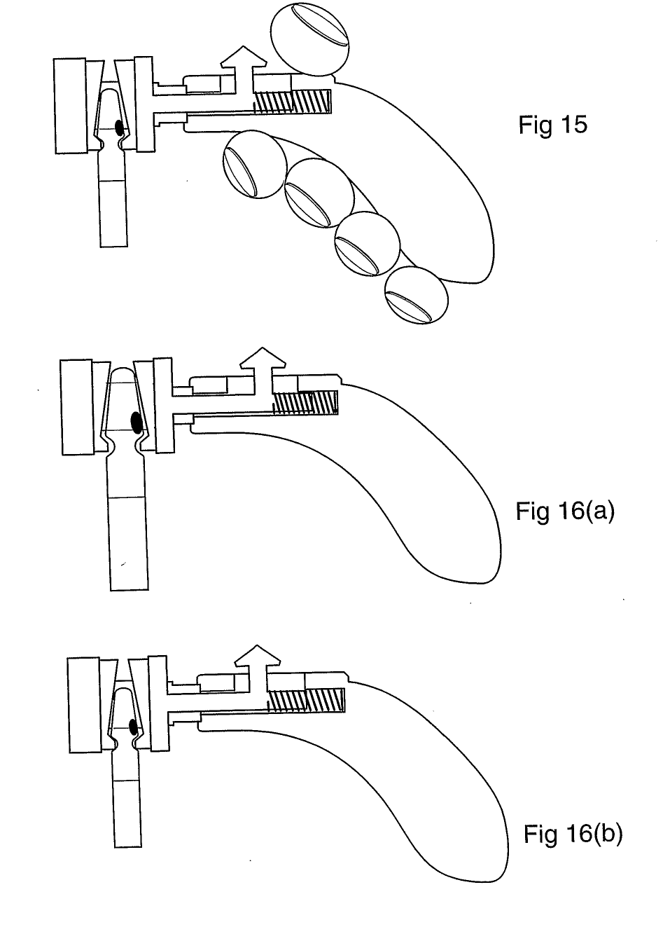

FIG. 15 illustrates, by way of example, the relative positions of the thumb 71 and fingers 72, 73, 74, 75 of a user on an apparatus during use.

FIGS. 16(a) and 16(b) illustrated an apparatus of the type illustrated in FIGS. 9 to 13 accommodating the heads of different-sized ampoules, immediately prior to opening.

It is to be understood that the terminology employed above is for the purpose of description and should not be regarded as limiting.

The foregoing embodiments are intended to be illustrative of the invention, and it is to be understood that the scope of the invention is not to be limited to the exact construction and operation described and illustrated, but only by the following claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be clearly understood that although prior art publication(s) are referred to herein, this reference does not constitute an admission that any of these documents forms part of the common general knowledge in the art in Australia or in any other country.

What is claimed is:

1.-18. (canceled)

19. An apparatus for opening an ampoule of the type having a detachable head portion, the apparatus comprising:
a body portion having a cavity adapted to receive therein at least part of the head portion of the ampoule;
a retaining device on the body portion for retaining the head portion at least partially within the cavity after it has been inserted therein, the retaining device having a resiliently expandable opening whose widest dimension at rest is less than the widest portion of the head portion, the retaining device being mounted on the body portion such that at least the widest portion of the head portion passes through the opening when the head portion is inserted into the cavity, and such that the retaining device is expanded by the passage of the head portion therethrough and then automatically constricts behind the widest portion of the head portion to releasably retain the head portion at least partially in the cavity; and
an ejection mechanism for contacting the head portion of the ampoule retained in the cavity and ejecting it from the cavity;
whereby in use, the head portion is detachable from the remainder of the ampoule by relative movement between (a) the body portion having the head portion retained at least partially in the cavity therein and (b) the remainder of the ampoule, and the detached head portion is engaged and ejectable from the cavity by the ejection mechanism.

20. An apparatus as claimed in claim 19, wherein the retaining device is a resiliently expandable annular device.

21. An apparatus as claimed in claim 20, wherein the retaining device is an O-ring of elastomeric material, at least partially located in an annular groove adjacent the entrance of the cavity in the body portion, and expandable outwardly within the annular groove.

22. An apparatus as claimed in claim 19, wherein the ejection mechanism comprises an elongate member slidable within the body portion, the elongate member being manually operable to contact the head portion of the ampoule retained within the cavity and eject it from cavity against the action of the retaining device.

23. An apparatus as claimed in claim 22, wherein the elongate member is resiliently biased towards the entrance of the cavity in the body portion and has an axis which is generally aligned with the centre of the entrance of the cavity, and further wherein the elongate member has a concave portion at its end adapted to contact the head portion of the ampoule and retain the head portion centrally relative to the entrance of the cavity after it has been detached.

24. An apparatus as claimed in claim 19, wherein the body portion is generally of tubular shape.

25. An apparatus as claimed in claim 24, wherein the body portion has a cavity at each axial end thereof, the cavity at one end being sized differently from the cavity at the other end.

26. An apparatus as claimed in claim 24, wherein the external surface of the body portion has a flat portion extending axially along its length, to prevent the body portion from freely rolling about its axis.

27. An apparatus for opening an ampoule of the type having a detachable head portion, the apparatus comprising:
a generally cylindrical body portion having a cavity at an end thereof adapted to receive the head portion of the ampoule;
a resiliently expandable O-ring having an opening whose widest dimension at rest is less than the widest portion of the head portion, the O-ring being mounted on the body portion at the entrance of the cavity such that it is laterally expandable to permit at least the widest portion of the head portion of the ampoule to pass through the opening when the head portion is inserted into the cavity, the O-ring being expanded by the passage of the head portion therethrough and then automatically constricting behind the widest portion of the head portion;
whereby after the head portion is detached from the remainder of the ampoule by relative movement between the body portion containing the head portion and the remainder of the ampoule, the head portion is retained within the cavity by the O-ring; and
and further comprising an elongate member slidable within the body portion, the elongate member being manually operable to contact the head portion of the ampoule and eject it from the cavity through the O-ring.

28. A method of opening an ampoule of the type having a detachable head portion, the method comprising:
holding the ampoule in a first hand with the head portion uppermost;
holding in the other hand with the thumb uppermost, an ampoule opener having (i) a cavity at its lower end adapted to receive the head portion of the ampoule, (ii) a retaining device for retaining the head portion at least partially within the cavity after it has been inserted therein, the retaining device having a resiliently expandable opening whose widest dimension at rest is less than the widest portion of the head portion, and (iii) an elongate member slidable within the ampoule opener;
inserting the head portion of the ampoule at least partially into the cavity, such that at least the widest portion of the head portion passes through the opening and the retaining device is expanded by the passage of the head portion therethrough and then automatically constricts behind the widest portion of the head portion to releasably retain the head portion at least partially in the cavity;
causing relative movement of the ampoule opener having the head portion retained therein and the remainder of the ampoule to thereby detach the head portion from the remainder of the ampoule; and
manually operating the elongate member to contact the head portion of the ampoule retained within the cavity and eject it from cavity against the action of the retaining device.
